(19) United States
(12) Patent Application Publication
(10) Pub. No.: US 2010/0082356 A1
(43) Pub. Date: Apr. 1, 2010

(54) SYSTEM AND METHOD FOR RECOMMENDING PERSONALIZED CAREER PATHS

(75) Inventors: Himanshu Verma, Bangalore (IN); Bhupesh Goel, Ballabgarh (IN); Anand Vishwanath Suvarnkar, Bangalore (IN)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/241,497

(22) Filed: Sep. 30, 2008

(51) Int. Cl. G06Q 10/00

(52) U.S. Cl. 705/1

(57) ABSTRACT

A candidate's career information is obtained. The career information comprises one or more of employment history information and education information. If the candidate's career information comprises employment history information, the employment history information is compared with stored employment history information of a plurality of individuals. If the candidate's career information comprises education information, the education information is compared with stored education information of a plurality of individuals. Stored career information meeting a similarity threshold is identified from one or more of the comparing steps. The similarity threshold relates to similarity between (1) the stored employment history information and the candidate's employment history information, and/or (2) the stored education information and the candidate's education information. The similarity threshold can also relate to a candidate's actions (e.g., apply history). A career path for the candidate is then determined based on the stored career information that has met the similarity threshold.

### FIELD

The present invention relates to career paths, and more specifically to a system and methods for recommending personalized career paths.

### BACKGROUND

On-line recruitment sites help people find new jobs by matching a person's profile against an available job bank. An individual typically wants to find the most suitable job for the individual. The most suitable job for an individual is often based on the individual's current skills, salary requirements, location, and/or experience.

A person's decision to accept a job offer is often influenced by a variety of factors, such as the person's knowledge of the company making the job offer, knowledge of the job market, and information obtained from the person's colleagues, friends, and family. These factors, however, may not lead to the best decision by the individual, as these factors are typically based on partial, limited, and/or biased information.

### SUMMARY

The present invention provides a system and methods for recommending personalized career options to an individual.

In one aspect, a candidate's career information is obtained. The career information comprises one or more of employment history information and education information. If the candidate's career information comprises employment history information, the employment history information is compared with stored employment history information of a plurality of individuals. If the candidate's career information comprises education information, the education information is compared with stored education information of a plurality of individuals. Stored career information meeting a similarity threshold is identified from one or more of the comparing steps. The similarity threshold relates to similarity between one or more of (1) the stored employment history information and the candidate's employment history information, and (2) the stored education information and the candidate's education information. A career path for the candidate is then determined based on the stored career information that has met the similarity threshold.

In one embodiment, a career recommendation is transmitted to a computer accessible by the candidate. The career recommendation is associated with the career path for the candidate. The obtaining of a candidate's career information can include receiving the candidate's career information, retrieving the candidate's career information from a memory, and/or automatically extracting the career information from a candidate's resume. In one embodiment, the stored employment history information is extracted (e.g., automatically, by a computer program) from a plurality of stored resumes. Further, the stored education information can also be extracted (automatically, by a computer program) from the plurality of stored resumes. A career graph can then be built (or updated) from the extracted employment history information and extracted education information, where the career graph comprises vertices and paths, and where each vertex in the vertices represents a career phase and each edge/path connects two vertices. The career graph can be built/updated using a k-means clustering algorithm. The career path for the candidate can then be determined based on the career graph.

In one embodiment, a query is received from the candidate regarding one or more of salary, skills, and title associated with a job. In one embodiment, the transmitting of a career recommendation includes transmitting one or more of a salary, skills, organization(s), and title associated with a career path. In one embodiment, a similarity between two or more organizations is determined. Multiple career paths for a candidate can also be ranked.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a computer transmitting career information to a server over a network in accordance with an embodiment of the present invention;

FIG. 2A is a flowchart illustrating the steps performed by the server of FIG. 1 to create a career graph in accordance with an embodiment of the present invention;

FIG. 2B is a flowchart illustrating the steps performed by the server of FIG. 1 to use the career graph to transmit one or more career paths to the computer of FIG. 1 in accordance with an embodiment of the present invention;

FIG. 3 is a graphical diagram of a career graph generated by the server of FIG. 1 in accordance with an embodiment of the present invention; and

FIG. 4 is a block diagram of a computer in accordance with an embodiment of the present invention.

### DESCRIPTION OF EMBODIMENTS

The present invention is now discussed in more detail referring to the drawings that accompany the present application. In the accompanying drawings, like and/or corresponding elements are referred to by like reference numbers.

Various embodiments of the present invention are disclosed herein; however, it is to be understood that the disclosed embodiments are merely illustrative of the invention that can be embodied in various forms. In addition, each of the examples given in connection with the various embodiments of the invention is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the present invention.

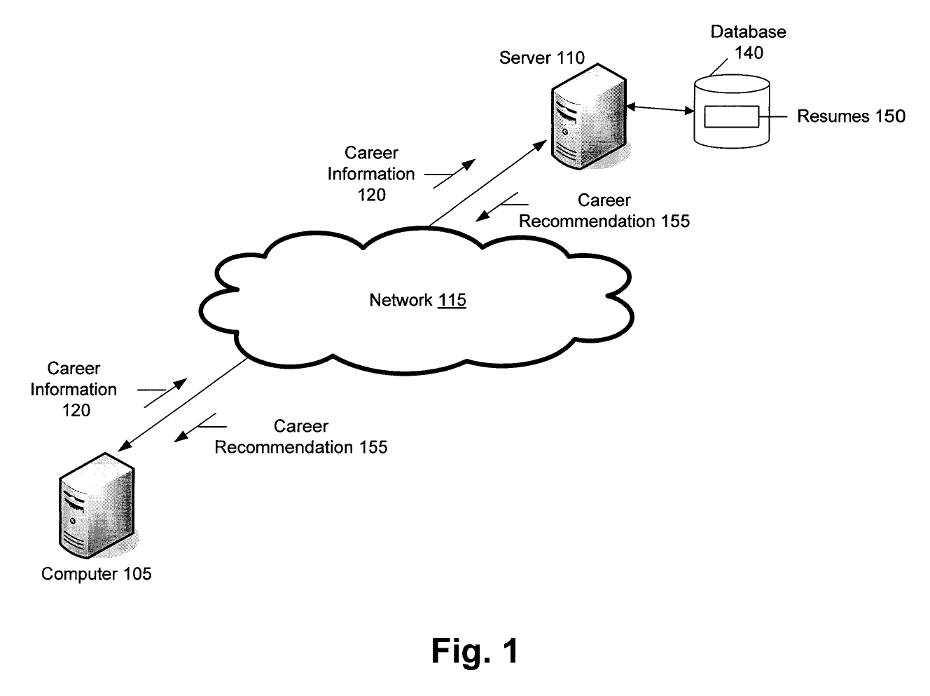

In one embodiment, and referring to FIG. 1, a computer 105 is in communication with a server 110 over a network 115, such as the Internet. For purposes of this disclosure, a computer such as the computer 105 includes a processor and memory for storing and executing program code, data and software. Computers can be provided with operating systems that allow the execution of software applications in order to manipulate data. Computer 105 can be any device that can display a website and that can be used by a user. Personal computers, servers, personal digital assistants (PDAs), wireless devices, cellular telephones, internet appliances, media players, home theater systems, and media centers are several non-limiting examples of computers.

For the purposes of this disclosure, a server such as the server 110 comprises software and/or hardware executing on one or more computers which receives information requests from other servers or computers, and responds to such requests. A number of program modules and data files can be stored on a computer readable medium of the server. They can include an operating system suitable for controlling the operation of a networked server computer, such as the WINDOWS VISTA, WINDOWS XP, or WINDOWS 2003 operating system published by Microsoft Corporation of Redmond, Wash., or the Ubuntu operating system distributed by Canonical Ldt. of Douglas, Isle of Mann.

For the purposes of this disclosure, a computer readable medium is a medium that stores computer data in machine readable form. By way of example, and not limitation, a computer readable medium can comprise computer storage media as well as communication media, methods or signals. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology; CD-ROM, DVD, or other optical storage; cassettes, tape, disk, or other magnetic storage devices; or any other medium which can be used to tangibly store the desired information and which can be accessed by the computer.

In one embodiment, the computer 105 transmits a candidate's career information 120 to the server 110 over network 115. Alternatively, the server 110 retrieves a candidate's career information 120 from storage (e.g., external or internal memory).

The career information 120 can be divided into employment history information and education information. Employment history information can include, but is not limited to, job title, company name, role in company, salary, field, and/or skills. Education information can include, but is not limited to, name of the college that the candidate attended, degree obtained, courses that the candidate took, specialization, and/or skills. In one embodiment, the candidate enters the candidate's career information 120 into a form of a web page displayed on the computer 105. In another embodiment, the candidate uploads the candidate's resume to the server 110 via the computer 105.

The server 110 obtains the candidate's career information 120 and compares the career information 120 with career information of a plurality of individuals (e.g., students and/or employees). In one embodiment, the career information of a plurality of individuals is stored in a database 140 in communication with the server 110. For example, and as described in more detail below, the server 110 may have obtained career information of a plurality of individuals previously from resumes 150 stored in the database 140.

Specifically, in one embodiment the candidate's employment history information is compared to stored employment history information extracted from the stored resumes 150. Further, in one embodiment, the candidate's education information is compared to stored education information extracted from the stored resumes 150. In another embodiment, a candidate's employment history information is compared to stored education information extracted from the stored resumes 150. Further, a candidate's education information can be compared to stored employment history extracted from the stored resumes 150.

The server 110 identifies, from the comparing, career information meeting a similarity threshold. The similarity threshold relates to the similarity between the identified career information and the candidate's career information 120. The similarity threshold can also be based on the candidate's actions (e.g., apply history) as collected by the server 110. In one embodiment, the candidate's actions are separate from the candidate's education information and employment history information.

In one embodiment, the server 110 then transmits a career recommendation 155 for the candidate to the computer 105 based on the identified career information. In one embodiment, the server 110 transmits the career recommendation 155 to the computer 105 by displaying the recommendation 155 on a website displayed at the computer 105. Alternatively, the career recommendation 155 may be an email, an audio announcement, an instant message, a text message, etc. In one embodiment, the server 110 stores the career recommendation for the user in storage (e.g., its internal or external memory). In one embodiment, the server 110 can generate career statistics based on stored career recommendations and/or career information. Although described herein as a single career recommendation 155, the server 110 may alternatively transmit a plurality of career recommendations for the candidate to the computer 105.

In one embodiment, the candidate also transmits career recommendation preferences to the server 110 in addition to the candidate's career information. Examples of career recommendation preferences include, but are not limited to, a ranking order for career recommendations (e.g., based on title and/or salary), desired future title/salary, etc.

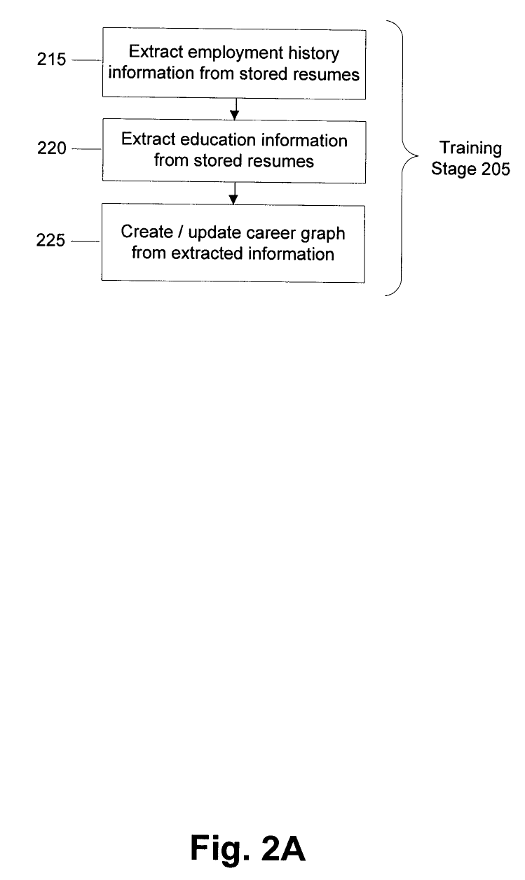

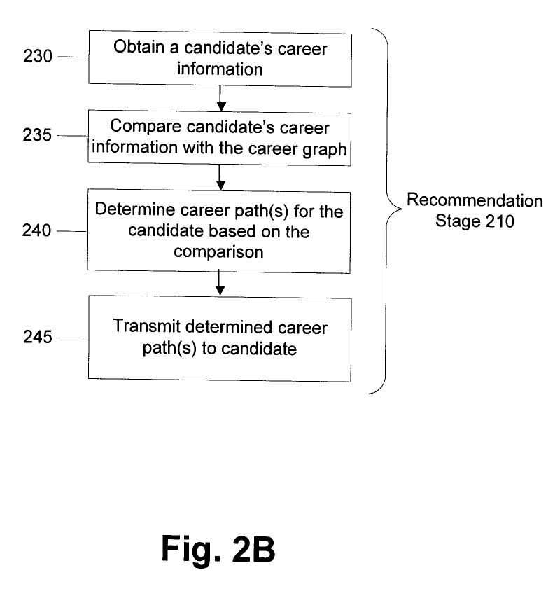

FIGS. 2A and 2B show flowcharts illustrating the steps performed by the server 110 to recommend one or more personalized career paths to a candidate. The server 110 performs two stages—a training stage 205 (data analysis to build persistent career graphs) and a recommendation stage 210. In one embodiment, the server 110 performs the training stage 205 before receiving the candidate's career information 120. In the training stage 205, the server 110 extracts career information of individuals from the resumes 150 stored in database 140. Specifically, the extracted career information includes employment history information and education information. In one embodiment, the server 110 performs the training stage 205 periodically, a predetermined number of times, after receiving new career information, etc. so that the career graph reflects current information.

In one embodiment, the employment history information includes career attributes (attributes that describe a career, such as job title, company name, etc.). The education information similarly can include education attributes (attributes that describe an individual's education, such as school name, degree obtained, etc.). The education information and the employment history information create one or more career phases. A career phase is the duration of which career/education attributes do not change for an individual. Specifically, the career phase can be of two types: (1) an educational phase, and (2) an job phase. An example of an educational phase is a Bachelor of Science degree in computer science from University Y. An example of a job phase is a Senior Software Engineer at Company S.

In one embodiment, the server 110 extracts a chronological order of career phases from each resume 150 in steps 215 and 220. In one embodiment, for employment history information, the server 110 extracts career attributes such as job title, company name, domain or field of the job, etc. For education information, the server 110 extracts education attributes, such as school attended, specialization, degree obtained, etc. In one embodiment, the server 110 extracts a skills attribute (from the career attributes and/or the education attributes). In one embodiment, the skills attribute is a vector attribute that is defined for the latest career phase.

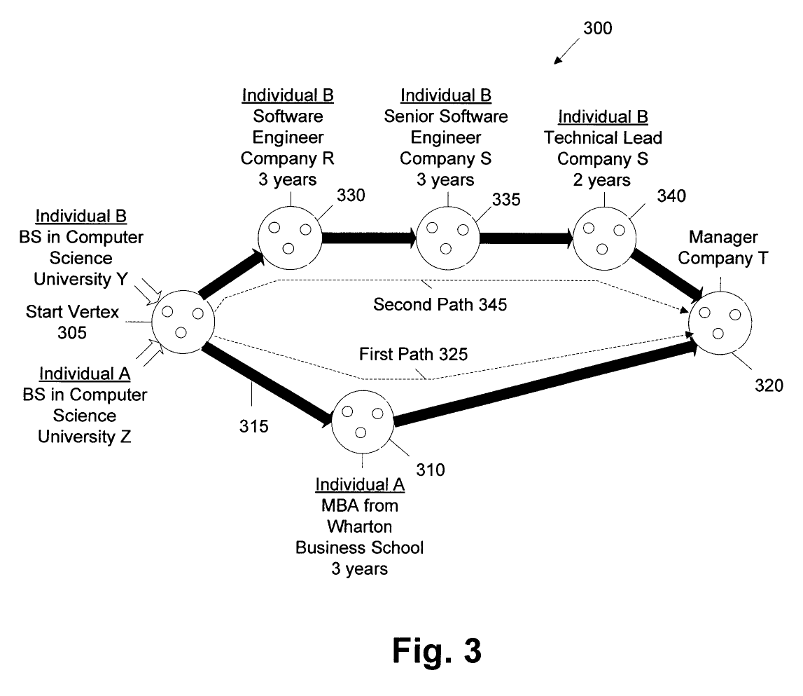

After extracting the career phase information for each resume in the stored resumes 150, the server 110 stores the extracted information as records in a relational database (e.g., in database 140). As described in more detail below (with respect to FIG. 3), the server 110 then creates (or updates) a career graph from the extracted career information in step 220.

The server 110 then enters the recommendation stage 210. In the recommendation stage 210, the server 110 has two inputs—the candidate's career information (supplied by the candidate via computer 105) and persistent career graph of the rest of the user population (as built in the training stage 205).

In particular, the server 110 obtains the candidate's career information 120 (e.g., from the computer 105) (step 230) and compares the obtained career information (education information and employment history information) to the career graph in step 235. The server 110 determines one or more career paths for the candidate based on this comparison in step 240. In one embodiment, the server 110 transmits the career path(s) to the candidate (e.g., to the computer 105) as career recommendation 155.

FIG. 3 shows an embodiment of a career graph 300 that the server 110 constructs from the stored resumes 150. In particular, the sequential career phases of each individual are extracted and stored as a path in the career graph 300.

Let G(V, E) represent a career graph. In one embodiment, each unique career phase in the stored resumes 150 is represented by a vertex in the graph G. In one embodiment, for every consecutive phase in an individual's career, an edge or path is created between corresponding vertices.

In one embodiment, the server 110 uses a k-means algorithm to create the career graph. Generally, a k-means algorithm is an algorithm to cluster n objects based on attributes into k partitions, where k<n. A k-means algorithm attempts to find the centers of natural clusters in the data, and the algorithm assumes that the object attributes form a vector space. The k-means algorithm typically attempts to minimize total intra-cluster variance.

The career graph G includes vertices and paths. With respect to the career graph G, k number of clusters are created out of the vertices. Let C₁, . . . Cₖ represent the k clusters. In one embodiment and as described in more detail below, proximity functions are defined for the career phases. In one embodiment, vᵢ [symbol] Cᵢ if vertex vᵢ falls in cluster Cᵢ. Let G′(V′, E′) be a new directed weighted career graph created from graph G such that the vertex set V′ is a set of the prototypes of the clusters C₁ to Cₖ. Let vertex v′ᵢ represent the cluster prototype for cluster Cᵢ. Two vertices v′ᵢ and v′ⱼ from V′ are connected if any vertex vᵢ in cluster Cᵢ is connected to any vertex vⱼ in cluster Cⱼ. Thus, two vertices in G′ are connected only if the minimum number of links between the clusters represented by them is more than a predetermined threshold value (e.g., numThreshold). Thus,

E′(G′)={(v′ᵢ , v′ⱼ)|{|(vₖ, v₁) [symbol] E(G), vₖ [symbol] Cᵢ, v₁ [symbol] Cᵢ, |>numThreshold}}

and the cost of edge (v′ᵢ, v′ⱼ) is defined as the number of links between the clusters represented by the vertices connected by the edge:

Cost(v′ᵢ, v′ⱼ)=|(vₖ, v₁)|vₖ [symbol] Cᵢ, v₁ [symbol] Cⱼ, (vₖ, v₁) [symbol] E(G)

Career graph 300 is an example of career graph G′. Career graph 300 includes vertices such as start vertex 305 and first A vertex 310 and paths such as start-vertex-to-first-A-vertex path 315.

The similarity between two career phases of the same type (education/job) can be defined as a weighted sum of proximities among each pair of attributes. In one embodiment, the similarity between two educational phases, EduCareerPhase1(Course1, Degree1, Institute1) and EduCareerPhase2(Course2, Degree2, Institute2) can be defined as:

Similarity(EduCareerPhase1, EduCareerPhase2)=W1*Proximity(Course1, Course2)+W2*Proximity(Degree1, Degree2)+W3*Proximity(Institute1, Institute2)+W4*Proximity(Skill 1, Skill2).

In one embodiment, the proximity between courses and degrees is defined using a similarity matrix that is built manually. Two institutes (e.g., colleges, universities, etc.) are considered similar if the student leaving the institutes join similar organizations. The equation for computing similarity between institute X and Y is:

Similarity(X,Y)=(SharedForwardCount(X,Y))/(ForwardCount(X)+ForwardCount(Y))

where
SharedForwardCount(a,b)=| { c | (a, c) and (b, c) where (a,c),(b,c) [symbol] G(V,E)}
ForwardCount(a)=| { c | (a,c) [symbol] G(V,E)} |
   In one embodiment, the proximity between institutes is defined based on their ranking in one or more (e.g., known or popular) surveys.

The proximity between skills can be computed as cosine similarity between the skill vectors. Generally, cosine similarity is a measure of similarity between two vectors of n dimensions by finding the angle between them. The similarity between two professional phases, ProfessionalPhase1(Role1, Org1, Skill1) and ProfessionalPhase2(Role2, Org2, Skill2) can be defined as:

Similarity(ProfessionalPhase1, ProfessionalPhase2)=W1*Proximity(Org1, Org2)+W2*Proximity(Skill1, Skill2)+W3*(Role1, Role2) where (Domain1==Domain2).

The proximity between skills can be computed as a cosine vector. In one embodiment, a very large organization can be viewed as equivalent to a small organization when considering the type of work assigned and the benefits offered. In one embodiment, organization similarity is based on their brand value and/or the quality of the people who work for the organization. In one embodiment, the server 110 uses the career graph 300 to determine the similarity between organizations. For example, if two people who had previously worked for the same company (e.g., regardless of position) join company X and Y, then organizations X and Y may be viewed as similar. Also, if two people working for companies X and Y join company U, then X and Y can be treated as similar. Therefore, in one embodiment, an equation for similarity between organizations X and Y is:

Similarity(X,Y)=(w1*SharedForwardCount(X,Y)+w2*SharedBackwardCount(X,Y))/(ForwardCount(X)*BackwardCount(X)*ForwardCount(Y)*BackwardCount(Y))

where
SharedForwardCount(a,b)=| { c | (a,c) and (b,c) where (a,c),(b,c) [symbol] G(V,E)} |
SharedBackwardCount(a,b)=| { d | (d,a) and (d,b) where (d,a),(d,b) [symbol] G(V,E)} |
   ForwardCount(a)=| { c | (a,c) [symbol] G(V,E)} |
   BackwardCount(a)=| { c | (c,a) [symbol] G(V,E)} |

W1 and W2 are weights to tune impact of forward and backward similarity.

Once the career graph G′ 300 is built, the server 110 can determine one or more career recommendations associated with a candidate's career information once the career information is obtained. In one embodiment, the server 110 transmits the career recommendation(s) 155 to the computer 105. Alternatively, the server 110 stores the career recommendation(s) in storage.

Specifically and in one embodiment, in order to receive a career recommendation 155 from the server 110, the candidate transmits the candidate's career information to the server 110. As described above, this career information can be used to find similar phases in other individuals' career history. Let (Xᵢ₁, Xᵢ₂, Xᵢₙ) be the attributes of the current phase of the candidate. In one embodiment, the algorithm to show possible future career paths for the candidate is:

Map I(Xᵢ₁, Xᵢ₂, Xᵢₙ) to cluster Cₐ such that Proximity(I,CPₐ) is minimum. Since cluster Cₐ maps to vertex s in career graph G′, all neighbors of s denote the next possible career option for the candidate. In one embodiment, the probability of each of the career options is computed as:

Prob(u|s)=cost(s, u)/Σcost(s, v) where (s, v) [symbol] E(G′)

In one embodiment, the vertices that can be reached from vertex s denote future career options possible for the candidate. Thus:

FutureOptions(s)={ u | Connected(s, u)}

If vertex u can be reached from s following (s,s₁, s₂, . . . sₙ₋₁, u), then the probability of reaching career phase u from phase s can be given by:

Prob(u|s)=Prob(s₁|s)*Prob(s₂ |S₁)* . . . Prob(u|sₙ₋₁).

In one embodiment, duration(u) is the average duration spent by individuals in phase Cᵢ. This duration is used to predict the future career of a candidate after n years. The duration to reach career phase u from s can be defined as:

TimeToReach(s, u)=Duration(s₁)+Duration(s₂) . . . Duration(sₙ₋₁).

In one embodiment, the career of the candidate after n years can be predicted as:

FuturePhase(s, n)={ u | Connected(s, u) and TimeToReach(s, u)=n}

Once the future career phases are predicted, in one embodiment the server 110 ranks the predicted career phases before turning one or more of the predicted career phases into a career recommendation. The Prob (u|s) gives the probability of reaching career phase u from career phase s where s is the phase closest to input phase I. Since s can be different from I, the net probability of reaching career phase u for input phase I can be given by:

Prob(i u)=Prob(s)*Prob(u|s)

Prob(s) is computed as Prob(s)=similarity(I,s)/Σsimilarity(I,x(i)) where I ranges from 1 to N for some constant N and the set of x(i) represents the N closest phases for input phase I.

In one embodiment, the predicted career options are ranked by the quality of the career phase. In particular, the ranking of the career options can be based on the title and/or salary of the career phase that can be reached with each of these career options, the length of time needed to reach the title and/or salary, etc.

The candidate may not be interested in every career option. For example, a particular candidate may specifically be interested in knowing the paths which lead to managerial positions. In one embodiment, the candidate specifies this information as part of the candidate's career information 120. The server 110 filters the stored career information to obtain career paths similar to the candidate's career information which lead to managerial positions. In one embodiment, filtering capability is provided by filtering the career options using the candidate provided criterion:

FuturePhase(s, n)={ u | Connected(s, u) and ConstraintSatisfied(u) and TimeToReach(s, u)<=n}

In one embodiment, the server 110 can also provide, as part of the career recommendation 155, the skills typically required for a particular title. The server 110 can also provide the names of organizations that are similar to an organization that the individual wanted to join. For example, if the candidate submits to the server 110 a name of an organization that the candidate wants to join (e.g., as part of the career information 120), the server 110 can provide to the candidate (as part of the career recommendation 155) names of organizations having similar positions (e.g., which can be useful to the candidate if the organization named as part of the career information 120 does not have any openings in the candidate's area of experience).

Still referring to FIG. 3, the start vertex 305 can represent the starting point for one or more individuals, such as Individual A and Individual B. Individual A has a Bachelor of Science (BS) degree in Computer Science from University Z. After obtaining a BS in Computer Science, Individual A's career path continues to first A vertex 310, where Individual A receives a Masters in Business Administration (MBA) from Wharton Business School in 3 years. Individual A's career path continues to an end vertex 320, where Individual A is a manager at Company T. Individual A's career path is shown as first career path 325.

Individual B has a different career path than Individual A. Individual B begins with a BS degree in Computer Science from University Y. The server 110 determines that University Y is similar to University Z and so, like Individual A, Individual B also begins at start vertex 305. Individual B then works for 3 years as a software engineer at Company R, as shown with first B vertex 330. Individual B then becomes a senior software engineer and works at Company S for three years in that capacity (second B vertex 335). Individual B then becomes a Technical Lead at Company S and works in that capacity for 2 years (third B vertex 340). Individual B then progresses to a Manager at Company T (end vertex 320). Individual B's career path is shown as second career path 345.

Thus, as shown in FIG. 3, the server 110 determines the career paths of individuals from the stored resumes 150 and builds a career graph 300. The server 110 obtains career information 120 (e.g., stored career information or transmitted career information) from a candidate and uses the career graph 300 to determine potential career paths for the candidate.

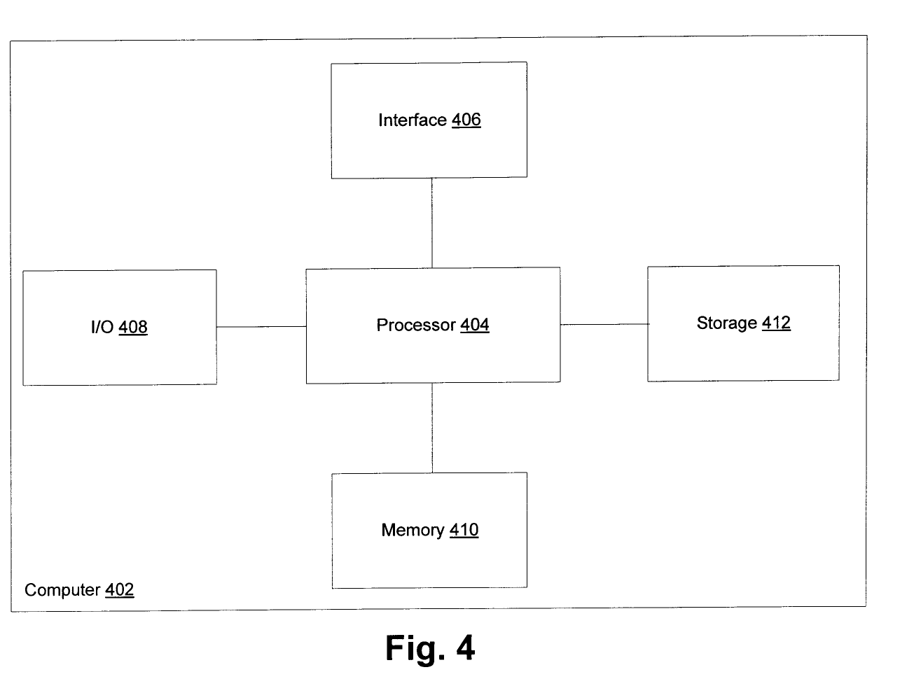

The description herewith describes the present invention in terms of the processing steps required to implement an embodiment of the invention. These steps can be performed by an appropriately programmed computer, the configuration of which is well known in the art. An appropriate computer can be implemented, for example, using well known computer processors, memory units, storage devices, computer software, and other components. A high level block diagram of such a computer is shown in FIG. 4. Computer 402 contains a processor 404 which controls the overall operation of computer 402 by executing computer program instructions which define such operation. The computer program instructions can be tangibly stored in a storage device 412 (e.g., magnetic or optical disk) and loaded into memory 410 when execution of the computer program instructions is desired. Computer 402 also includes one or more interfaces 406 for communicating with other devices (e.g., locally or via a network). Computer 402 also includes input/output 408 which represents devices which allow for user interaction with the computer 402 (e.g., display, keyboard, mouse, speakers, buttons, etc.).

One skilled in the art will recognize that an implementation of an actual computer will contain other components as well, and that FIG. 4 is a high level representation of some of the components of such a computer for illustrative purposes. In addition, the processing steps described herein can also be implemented using dedicated hardware, the circuitry of which is configured specifically for implementing such processing steps. Alternatively, the processing steps can be implemented using various combinations of hardware, firmware and software.

Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client or server or both. In this regard, any number of the features of the different embodiments described herein can be combined into single or multiple embodiments, and alternate embodiments having fewer than, or more than, all of the features described herein are possible. Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

The foregoing Description is to be understood as being in every respect illustrative and exemplary, but not restrictive, and the scope of the invention disclosed herein is not to be determined from the Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method comprising:
obtaining a candidate's career information, the career information comprising one or more of employment history information and education information;
if the candidate's career information comprises employment history information, comparing the employment history information with stored employment history information of a plurality of individuals;
if the candidate's career information comprises education information, comparing the education information with stored education information of a plurality of individuals;
identifying, from one or more of the comparing steps, stored career information meeting a similarity threshold, the similarity threshold relating to similarity between one or more of (1) the stored employment history information and the candidate's employment history information and (2) the stored education information and the candidate's education information; and
determining, by a computer, a career path for the candidate based on the stored career information that has met the similarity threshold.

2. The method of claim 1, further comprising transmitting a career recommendation to a computer accessible by the candidate, the career recommendation being associated with the career path for the candidate.

3. The method of claim 1, wherein the obtaining a candidate's career information further comprises receiving the candidate's career information.

4. The method of claim 1, wherein the obtaining a candidate's career information further comprises retrieving the candidate's career information from a memory.

5. The method of claim 1, further comprising:
automatically extracting the stored employment history information from a plurality of stored resumes;
automatically extracting the stored education information from the plurality of stored resumes; and
building a career graph from the extracted employment history information and extracted education information, wherein the career graph comprises vertices and paths, each vertex in the vertices representing a career phase and each path connecting two vertices.

6. The method of claim 5, further comprising determining the career path for the candidate based on the career graph.

7. The method of claim 2, further comprising receiving a query from the candidate regarding one or more of salary, skills, and title associated with a job.

8. The method of claim 7, wherein the transmitting a career recommendation further comprises transmitting one or more of a salary, skills, organization, and title associated with the career path.

9. The method of claim 6, further comprising determining a similarity between two or more organizations.

10. The method of claim 1, wherein the obtaining a candidate's career information further comprises extracting the candidate's career information from a resume.

11. The method of claim 5, wherein the building of the career graph further comprises building the career graph using a k-mean clustering algorithm.

12. The method of claim 1, further comprising ranking a plurality of career paths for the candidate.

13. A computer readable medium storing computer program instructions capable of being executed by a computer processor, the computer program instructions defining the steps of:
obtaining a candidate's career information, the career information comprising one or more of employment history information and education information;
if the candidate's career information comprises employment history information, comparing the employment history information with stored employment history information of a plurality of individuals;
if the candidate's career information comprises education information, comparing the education information with stored education information of a plurality of individuals;
identifying, from one or more of the comparing steps, stored career information meeting a similarity threshold, the similarity threshold relating to similarity between one or more of (1) the stored employment history information and the candidate's employment history information and (2) the stored education information and the candidate's education information; and
determining a career path for the candidate based on the stored career information that has met the similarity threshold.

14. The computer readable medium of claim 13, further comprising computer program instructions defining the step of transmitting a career recommendation to a computer accessible by the candidate, the career recommendation being associated with the career path for the candidate.

15. The computer readable medium of claim 13, wherein the computer program instructions defining the step of obtaining a candidate's career information further comprises computer program instructions defining the step of receiving the candidate's career information.

16. The computer readable medium of claim 13, wherein the computer program instructions defining the step of obtaining a candidate's career information further comprises computer program instructions defining the step of retrieving the candidate's career information from a memory.

17. The computer readable medium of claim 13, further comprising computer program instructions defining the steps of:
automatically extracting the stored employment history information from a plurality of stored resumes;
automatically extracting the stored education information from the plurality of stored resumes; and
building a career graph from the extracted employment history information and extracted education information, wherein the career graph comprises vertices and paths, each vertex in the vertices representing a career phase and each path connecting two vertices.

18. The computer readable medium of claim 17, further comprising computer program instructions defining the step of determining the career path for the candidate based on the career graph.

19. The computer readable medium of claim 18, wherein the computer program instructions defining the step of transmitting a career recommendation further comprises computer program instructions defining the step of transmitting one or more of a salary, skills, organization, and title associated with the career path.

20. The computer readable medium of claim 19, further comprising computer program instructions defining the step of determining a similarity between two or more organizations.

21. The computer readable medium of claim 17, wherein the computer program instructions defining the step of building the career graph further comprises computer program instructions defining the step of building the career graph using a k-means clustering algorithm.
